(19) United States
(12) Patent Application Publication
(10) Pub. No.: US 2016/0229356 A1
(43) Pub. Date: Aug. 11, 2016

(54) VEHICLE ACCESSORY MOUNTING ASSEMBLY

(71) Applicant: JARROD R. NOLAN, WICHITA, KS (US)

(72) Inventor: JARROD R. NOLAN, WICHITA, KS (US)

(21) Appl. No.: 15/017,017

(22) Filed: Feb. 5, 2016

Related U.S. Application Data
(60) Provisional application No. 62/112,539, filed on Feb. 5, 2015.

(51) Int. Cl. B60R 11/06

(52) U.S. Cl. CPC B60R 11/06; B60R 2011/004

(57) ABSTRACT

A mounting assembly for securing one or more accessories to a surface, the mounting assembly including a base layer, an upper layer positioned above the base layer, a number of support members between the base layer and the upper layer, and a number of lock anchors spaced apart from each other for receiving locking mechanisms of accessories positioned thereon. The lock anchors each include an open-topped central cavity for receiving the retractable locking mechanisms therein and one or more side openings for at least partially receiving an extendable locking member of one of the retractable locking mechanisms therein.

### RELATED APPLICATIONS

This non-provisional patent application claims priority benefit with regard to all common subject matter of earlier-filed U.S. Provisional Patent Application Ser. No. 62/112,539, filed on Feb. 5, 2015, and entitled “VEHICLE ACCESSORY MOUNTING ASSEMBLY.” The identified earlier-filed provisional patent application is hereby incorporated by reference in its entirety into the present application.

### BACKGROUND

Accessory mounting assemblies are often used to mount toolboxes, cargo, and other devices to vehicles, floors, shelves, and other surfaces. Conventional mounting assemblies often limit the position and arrangement of the accessory such that space on the surface is wasted and such that the accessory cannot be accessed when mounted on the surface. Conventional mounting assemblies also often protrude from the surface, thus forming a tripping hazard and/or further wasting space on the surface. Locking features on conventional mounting assemblies often do not fully lock or can unintentionally become unlocked when other equipment or cargo inadvertently contact them.

### SUMMARY

Embodiments of the present invention solve the above-mentioned problems and provide a distinct advance in the art of accessory mounting assemblies. More particularly, the present invention provides an accessory mounting assembly for securing accessories to a surface in an organized array such that the accessory mounting assembly does not protrude from the surface.

An embodiment of the mounting assembly broadly includes a base layer, an upper layer positioned above the base layer, a number of support members between the base layer and the upper layer, and a number of lock anchors spaced apart from each other for receiving locking mechanisms of accessories positioned thereon. The lock anchors each include an open-topped central cavity for receiving the retractable locking mechanisms therein and one or more side openings for at least partially receiving an extendable locking member of one of the retractable locking mechanisms therein. The lock anchors are positioned on the base layer and are accessible through the upper layer so that the lock anchors do not protrude above the upper layer. This eliminates tripping hazards and prevents the accessories from unintentionally becoming unlocked from the surface.

Another embodiment of the mounting assembly broadly includes a base layer, an upper layer positioned above the base layer, a number of support members between the base layer and the upper layer, and a number of lock anchors for receiving locking mechanisms of accessories positioned thereon. The base layer and the upper layer may include contours for positioning the mounting assembly in a truck bed, trailer bed, or on another vehicle surface. The lock anchors each include an open-topped central cavity for receiving the retractable locking mechanisms therein and one or more side openings for at least partially receiving an extendable locking member of one of the retractable locking mechanisms therein.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawings figures.

### BRIEF DESCRIPTION OF THE DRAWING FIGURES

Embodiments of the present invention are described in detail below with reference to the attached drawing figures, wherein:

FIG. 1 is an assembly view of an accessory mounting assembly constructed in accordance with an embodiment of the present invention;

FIG. 2 is a perspective view of a lock anchor of the accessory mounting assembly of FIG. 1;

FIG. 3 is a perspective view of an engagement knob of a retractable locking mechanism constructed in accordance with an embodiment of the present invention;

FIG. 4 is; a perspective view of a retractable locking mechanism constructed in accordance with an embodiment of the present invention;

FIG. 5 is a partial cutaway view of the retractable locking mechanism of FIG. 4; and

FIG. 6 is a perspective view of a number of accessories stacked vertically in accordance with an embodiment of the present invention.

The drawing figures do not limit the present invention to the specific embodiments disclosed and described herein. The drawings are not necessarily to scale, emphasis instead being placed upon clearly illustrating the principles of the invention.

### DETAILED DESCRIPTION OF THE EMBODIMENTS

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

In this description, references to one embodiment“, an embodiment”, or “embodiments” mean that the feature or features being referred to are included in at least one embodiment of the technology. Separate references to one embodiment“, an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

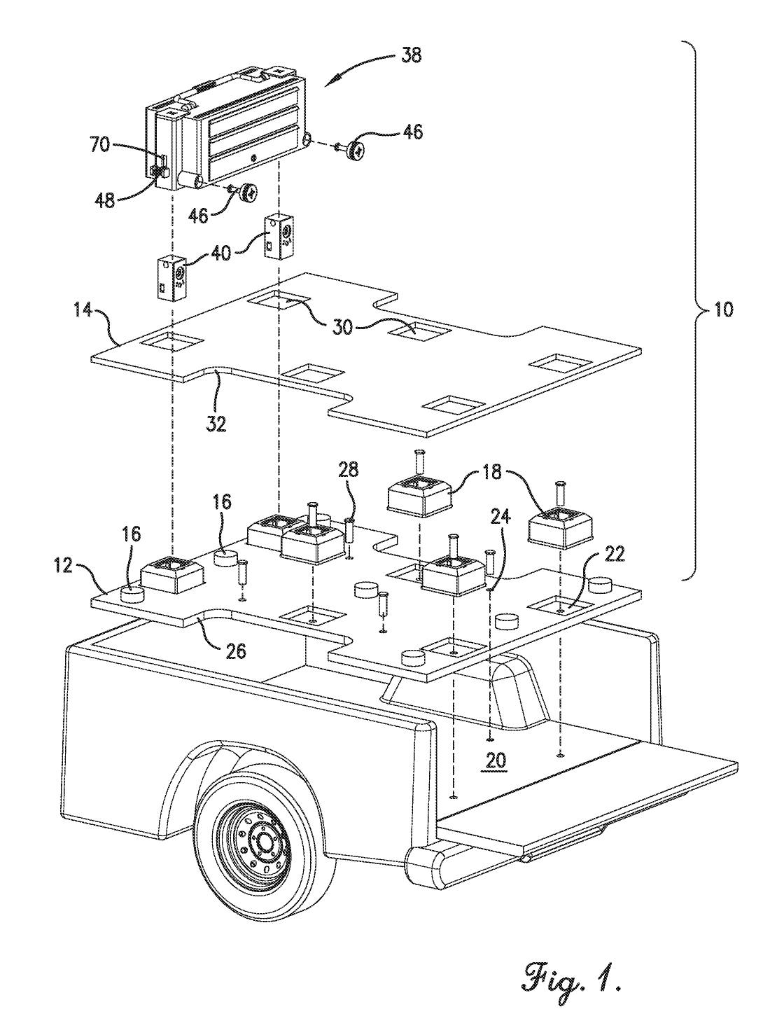

With reference to FIG. 1, a vehicle accessory mounting assembly constructed in accordance with a preferred embodiment of the invention is illustrated. The vehicle accessory mounting assembly 10 broadly comprises a base layer 12, an upper floor layer 14, a plurality of support members 16, and a plurality of lock anchors 18.

The base layer 12 supports the accessory mounting assembly in a vehicle bed 20 or other surface such as the bed of a truck or a storage shelf and may be formed of molded plastic, wood, metal, or any other suitable material. The base layer 12 includes a plurality of lock anchor recesses 22, a plurality of vehicle bed fastener openings 24, and left and right wheel well contours 26. The base layer 12 may be sized to fit within any sized vehicle bed. Embodiments of the base layer 12 may also be configured for mounting in other places such as in a vehicle trunk.

The lock anchor recesses 22 receive the lock anchors 18 therein and may be square, rectangular, circular, or any other suitable shape. The lock anchor recesses 22 may be cavities or openings and may be arranged in a uniformly distributed pattern in lateral and longitudinal directions. In one embodiment, the lock anchor recesses 22 may be arranged in an orthogonal pattern with five rows with twenty-four lock anchor recesses total such that the first, fifth, and sixth rows have five lock anchor recesses each and the second, third, and fourth rows have three lock anchor recesses each.

The vehicle bed fastener openings 24 receive vehicle bed fasteners 28 therethrough and may be threaded and/or circular openings. In one embodiment, the vehicle bed fastener openings 24 may include eight openings with four openings positioned near left and right sides of the base layer 12 for securing the base layer 12 to the vehicle bed 20 by tightening the vehicle bed fasteners 28 through the vehicle bed fastener openings 24 into corresponding fastener openings in the vehicle bed 20. The vehicle bed fastener openings 24 may be positioned so that an in-bed utility hitch may be used between the wheel wells in conjunction with the vehicle accessory mounting assembly 10.

The left and right wheel contours 26 may be large cut-out shapes extending inwardly from left and right sides of the base layer 12 for accommodating raised wheel well areas of the vehicle bed 20.

The upper floor layer 14 supports accessories and cargo thereon and may be formed of molded plastic, wood, metal, or any other suitable material. The upper floor layer 14 may include a plurality of lock anchor upper openings 30 and left and right wheel well contours 32. In one embodiment, the upper floor layer 14 may be sealed to the truck bed or other surface.

The lock anchor upper openings 30 receive the lock anchors 18 therethrough and may be square, rectangular, circular, or any other suitable shape. In one embodiment, the lock anchor upper openings 30 may be arranged in a uniformly distributed pattern in lateral and longitudinal directions. The lock anchor upper openings 30 may be arranged to correspond with the locations of the lock anchor recesses 22.

The left and right wheel well contours 32 may be similar to and positioned above the left and right wheel contours 26 of the base layer 12 for accommodating the raised wheel well areas of the vehicle bed 20.

The plurality of support members 16 distribute the weight of the accessories and cargo and absorb shocks and vibrations transmitted from the vehicle for protecting the accessories and cargo. The support members 16 are positioned between the base layer 12 and the upper floor layer 14 and spaced apart from each other. The support members 16 may be formed of shock absorbing material and/or may be shaped to dissipate the shock forces. In one embodiment, the support members 16 are clipped to the upper floor layer 14 for securing the upper floor layer 14 to the support members 16.

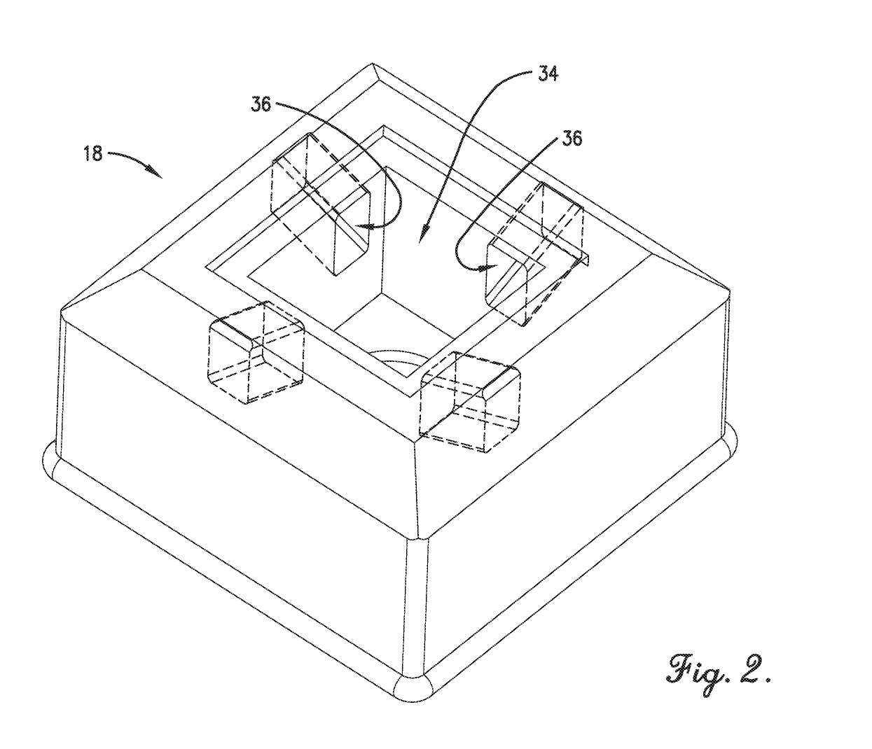

The plurality of lock anchors 18 secure retractable locking mechanisms (described below) of the accessories thereto and are positioned in the lock anchor recesses 22. The lock anchors 18 each may include an open-topped central cavity 34 and one or more side openings 36, as shown in FIG. 2. In other embodiments, the lock anchors 18 may be shaped and/or integrated into the base layer 12 and/or the upper floor layer 14 for receiving locking mechanisms of the accessories shaped differently than the retractable locking mechanisms described below.

The open-topped central cavity 34 receives the retractable locking mechanisms therein and may be square, rectangular, circular, or other suitable shape. The open-topped central cavity 34 may have drainage holes and/or mounting holes at the bottom thereof.

The one or more side openings 36 each receive an extendable locking member (described below) therein for securing the retractable locking mechanism in the open-topped central cavity 34. The one or more side openings 36 may be channels, recesses, slots, catches, or similar features and may extend diagonally upwards and outwards from any of the sides (such as opposite sides or all sides) of the open-topped central cavity 34. The one or more side openings 36 may be angled at 26 degrees (1 degree less than the extendable locking members described below) to encourage friction therebetween as the extendable locking members are engaged.

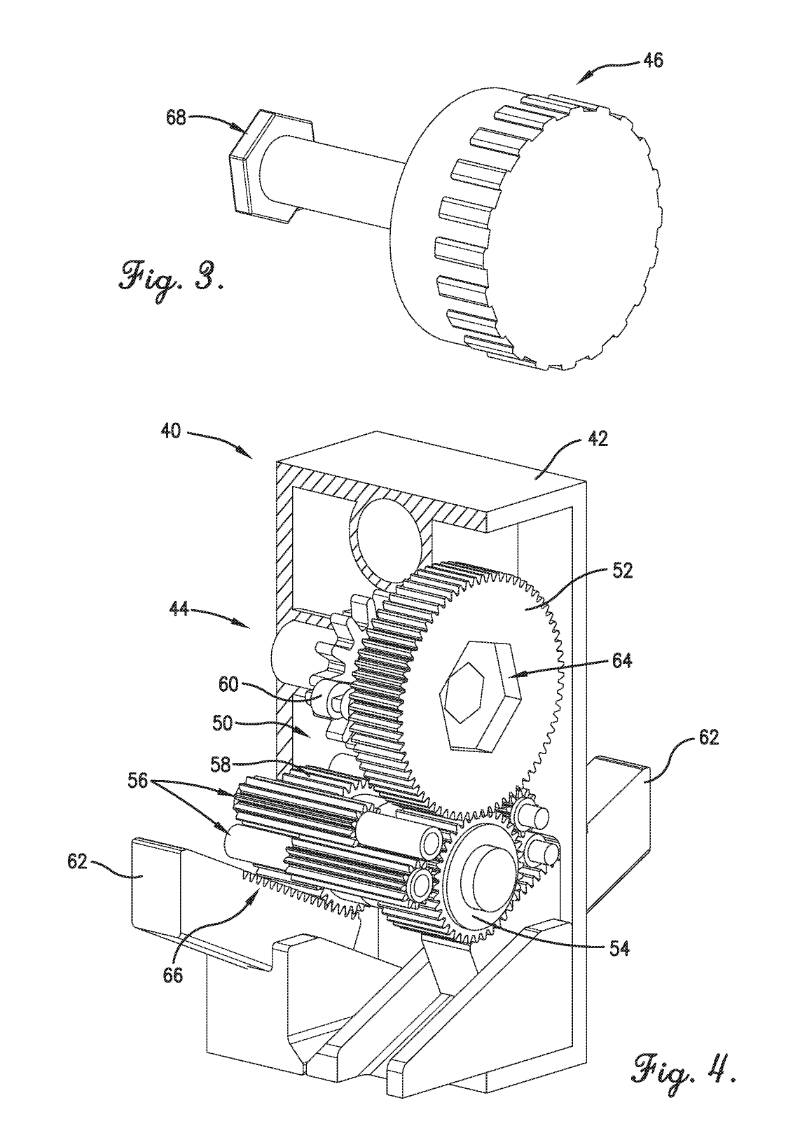

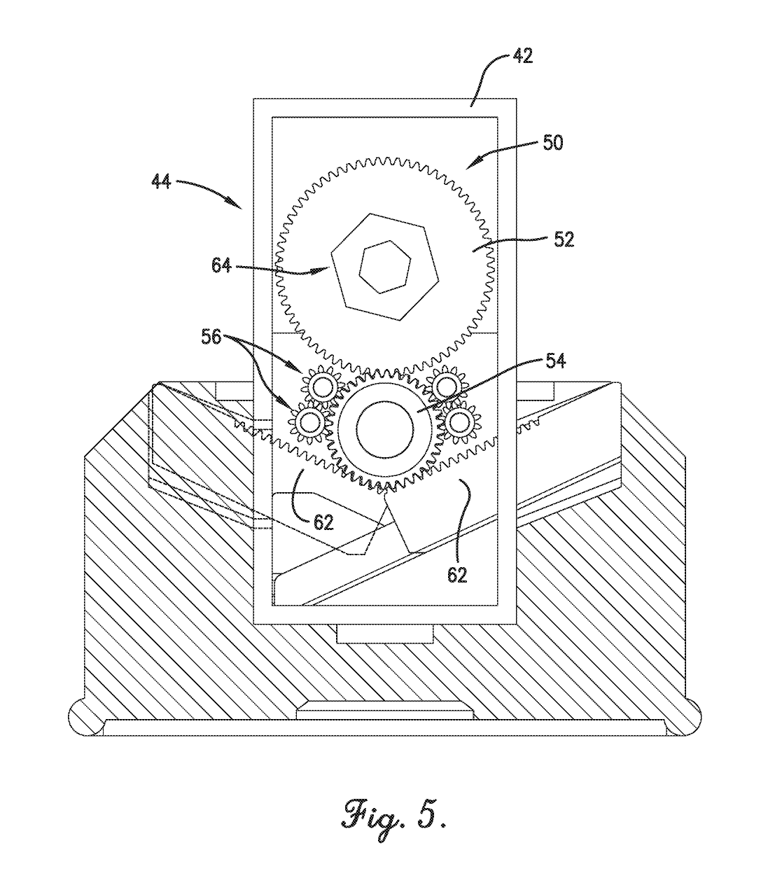

Turning to FIGS. 3-6, accessories 38 such as toolboxes, containers, chests, cargo, and other objects can be secured to the accessory mounting assembly 10. The accessories 38 each include retractable locking mechanisms 40 for securing the accessories 38 to the upper layer 14 of the accessory mounting assembly 10. Each retractable locking mechanism 40 broadly comprises a gear carriage 42, a gear assembly 44, a knob 46, and a retractor lever 48, as shown in FIGS. 1 and 3-5.

The gear carriage 42 supports the gear assembly 44 and may be substantially square, rectangular, or other similar shape. The gear carriage 42 may include a cavity 50 for receiving the gear assembly 44 therein and one or more side openings for receiving gear shafts and the extendable locking members (described below) therethrough.

The gear assembly 44 converts a force received from the knob 46 into a locking motion and includes a driver gear 52, a primary gear 54, a number of transfer gears 56, a secondary gear 58, one or more extendable locking members 62. It will be understood that other force transfer and force conversion configurations, assemblies, and components such as pulleys, linkages, cams, bearings, and levers may be used.

The driver gear 52 receives rotational force from the knob 46 and transfers the force to the primary gear 54. The driver gear may include an engagement recess 64 or protrusion having a hexagonal, star, square, or similar shape for rotationally and engaging (and being disengaged from) the knob 46. The driver gear 52 may be spring loaded along its rotational axis and may be configured to engage a catch 60 when the spring force is unloaded such that the gear assembly 44 is unable to turn unless the driver gear 52 is urged against the spring force via the knob 46.

The primary gear 54 transfers rotational force from the driver gear 52 to one of the extendable locking members 62 and to the transfer gears 56. The transfer gears 56 transfer rotational force from the primary gear 54 to the secondary gear 58. The secondary gear 58 transfers rotational force to one or more other extendable locking members 62.

The extendable locking members 62 shift between retracted unlocked positions and extended locked positions when the knob 46 is turned by converting rotational force from the primary gear 54 and the secondary gear 58 into translational movement. The extendable locking members 62 may be 1.5 inches long and 1 inch wide. The extendable locking members 62 may include teeth 66 that are engaged by the gear teeth of the primary driver gear 52 and the secondary gear 58. The extendable locking members 62 may be angled upwards at approximately 27 degrees for improved leverage.

The knob 46 allows a user to lock the retractable locking mechanisms 40 to, and unlock the retractable locking mechanisms 40 from, the accessory mounting assembly 10. The knob 46 may include a shaft with a hexagonal, star, square, or similarly shaped shaft end 68 for rotationally engaging the driver gear 52.

The retractor lever 48 shifts the retractable locking mechanism 40 between deployed and un-deployed positions and may extend through a vertical slot 70 in the accessory 38, as shown in FIG. 1. The retractor lever 48 may be spring loaded and may be lockable in the deployed and/or un-deployed positions.

It will be understood that other locking mechanisms such as hook and latch locking mechanisms or any other securing mechanisms may be used instead of the retractable locking mechanisms 40.

Use of the vehicle accessory mounting assembly 10 will now be described in more detail. First, the vehicle accessory mounting assembly 10 may be mounted in a truck bed, trunk, trailer, or similar cargo area, storage space, shelf, or other surface by tightening the vehicle bed fasteners 28 through the vehicle bed fastener openings 24 of the base layer 12 to the cargo area. An accessory 38 such as a toolbox or toolkit may be placed on the upper layer 14 of the vehicle accessory mounting assembly 10. The retractable locking mechanisms 40 of an accessory 38 may be aligned with one or more of the lock anchors 18 so as to organize one or more accessories on the vehicle accessory mounting assembly 10 as desired. The accessory 38 may be oriented laterally or longitudinally so long as the retractable locking mechanisms 40 are aligned with the lock anchors 18. The retractor levers 48 of the accessory 38 may then be pushed downward so as to shift the retractable locking mechanisms 40 into a deployed position within the open-topped cavities 34 of the lock anchors 18.

Each retractable locking mechanism 40 may be locked to the vehicle accessory mounting assembly 10 as follows. The knob 46 may then be pushed axially inward so that the knob 46 engages the driver gear 52 and frees the driver gear 52 from the catch 60. The knob 46 may then be rotated so as to transfer a rotational force through the gear assembly 44 to the extendable locking members 62 and urge the extendable locking members 62 outward into the side openings 36 of the lock anchors 18 in a locking position. The knob 46 may then be pulled axially outward to disengage the knob 46 from the gear assembly 44 such that the driver gear engages the catch 60 and prevents the retractable locking mechanism 40 from being unlocked. The accessory 38 will thus be locked in place on the vehicle accessory mounting assembly 10.

The retractable locking mechanism 40 may then be unlocked from the vehicle accessory mounting assembly 10 as follows. The knob 46 may be pushed axially inward so that the knob 46 again engages the driver gear 52 and frees the driver gear 52 from the catch 60. The knob 46 may then be rotated so as to transfer a rotational force to the extendable locking members 62 and retract the extendable locking members 62 from the side openings 36 of the lock anchors 18. The retractor lever 48 may then be pulled upwards to urge the retractable locking mechanism 40 from the open-topped central cavity 34 of the lock anchor 18. The knob 46 may then be pulled axially outward to disengage the knob 46 from the gear assembly 44 and re-engage the driver gear 52 with the catch 60 to prevent the retractable locking mechanism 40 from unintentionally shifting to a locked position. The accessory 38 may then be picked up and/or rearranged as desired.

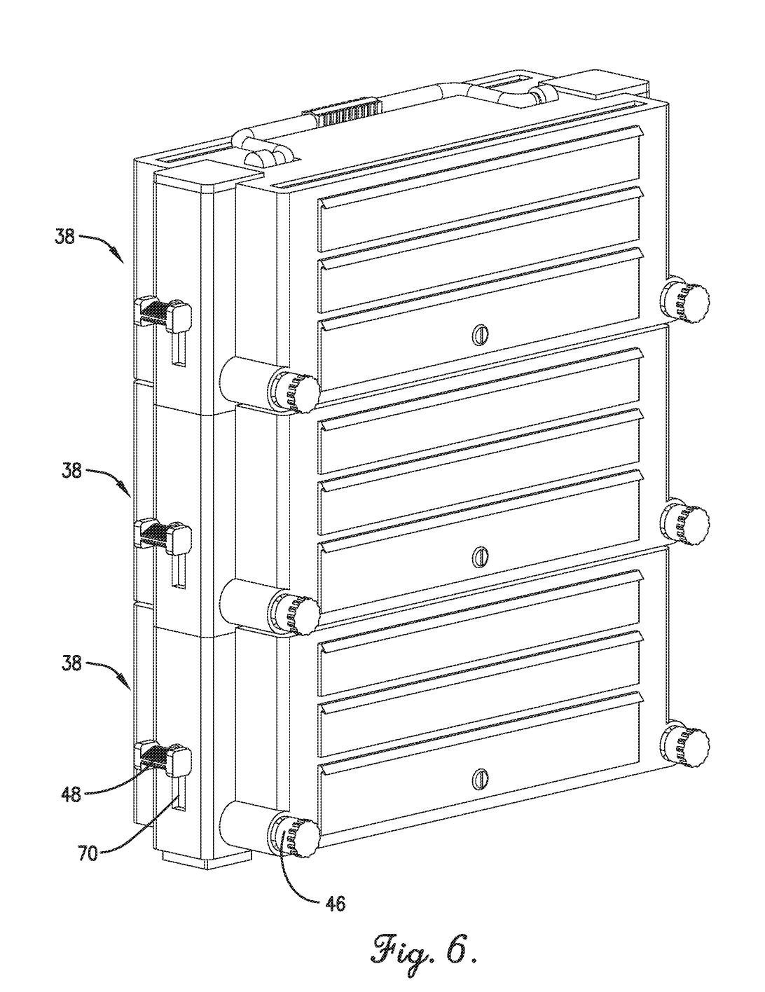

It will be understood that the vehicle accessory mounting assembly 10 may be used in truck and other vehicle beds, in vehicle trunks, on top of truck bed walls, in or on trailers, vehicle roofs and vehicle roof racks, all-terrain vehicles (ATVs), aircraft, stud walls, garages, and any other location for temporarily or permanently storing, transporting, securing, and arranging accessories and vehicle components. For example, the vehicle accessory mounting assembly may be formed into “one segment” strips having a single row of lock anchors. The strips may be mounted to wall studs for attaching wall accessories and features such as cabinets, benches, shelves thereto. The strips may also be mounted to the floor of an aircraft for anchoring aircraft seats thereto. In other embodiments, the strips may be mounted in or on a trailer, an SUV, a car, or other implement. In some embodiments, as shown in FIG. 6, the accessories 38 may be stacked on top of each other for further organized transport or storage.

The present invention provides many advantages over prior art accessory mounting assemblies. For example, the vehicle accessory mounting assembly 10 allows the user to positively lock accessories in place without additional clamps, hooks, cables, or netting. The vehicle accessory mounting assembly 10 allows the user freedom to rearrange accessories as desired and allows any accessories with retractable locking mechanisms 40 to be attached to the vehicle accessory mounting assembly 10. The vehicle accessory mounting assembly 10 also absorbs shocks and vibrations between the vehicle and the accessories to prevent the accessories from becoming damaged. The retractable locking mechanisms 40 retract completely into the accessories to protect the retractable locking mechanisms 40 and to prevent them from catching on other objects when not in use. The vehicle accessory mounting assembly 10 also protects the vehicle bed from exposure to the elements and damage from the accessories.

Although the invention has been described with reference to the embodiments illustrated in the attached drawing figures, it is noted that equivalents may be employed and substitutions made herein without departing from the scope of the invention.

1. A mounting assembly for securing one or more accessories to a surface, the mounting assembly comprising:
a base layer configured to be positioned on the surface;
an upper layer positioned above the base layer;
one or more support members positioned between the base layer and the upper layer and configured to support the upper layer above the base layer; and
one or more lock anchors configured to receive one or more retractable locking mechanisms of the one or more accessories therein, the one or more lock anchors each comprising:
an open-topped central cavity configured to at least partially receive one of the retractable locking mechanisms therein; and
one or more side openings each configured to at least partially receive an extendable locking member of one of the retractable locking mechanisms therein.

2. The mounting assembly of claim 1, wherein the one or more side openings extend diagonally upwards and outwards.

3. The mounting assembly of claim 1, wherein the one or more side openings includes two side openings extending from opposite sides of the open-topped central cavity.

4. The mounting assembly of claim 3, wherein the side openings are offset from each other.

5. The mounting assembly of claim 1, wherein the one or more side openings are channels configured to engage the extendable locking members via friction so as to resistively retain the extendable locking members therein.

6. The mounting assembly of claim 1, wherein the support members are at least partially formed of shock absorbing material.

7. The mounting assembly of claim 1, wherein the one or more support members are configured to distribute the weight of the one or more accessories.

8. The mounting assembly of claim 7, wherein the one or more support members are evenly spaced from each other.

9. The mounting assembly of claim 1, wherein the base layer includes a plurality of fastener openings configured to receive fasteners therethrough for securing the base layer to the surface.

10. The mounting assembly of claim 1, wherein the one or more lock anchors are integrated into the base layer or upper layer.

11. The mounting assembly of claim 1, wherein the upper layer is sealed to the surface.

12. The mounting assembly of claim 1, wherein the base layer further comprises lock anchor recesses configured to receive the lock anchors therein.

13. The mounting assembly of claim 1, wherein the upper layer has a plurality of lock anchor openings configured to receive the lock anchors therethrough.

14. The mounting assembly of claim 13, wherein the plurality of lock anchor openings on the upper layer are aligned with lock anchor recesses on the base layer.

15. The mounting assembly of claim 13, wherein the plurality of lock anchors are uniformly spaced from each other.

16. The mounting assembly of claim 13, wherein the plurality of lock anchors are arranged in an orthogonal pattern such that the mounting assembly is configured to secure a plurality of accessories in longitudinal and lateral orientations.

17. The mounting assembly of claim 1, wherein each lock anchor is rectangular shaped.

18. A mounting assembly for securing one or more accessories to a surface of a vehicle, the mounting assembly comprising:
a base layer configured to be positioned on the surface;
an upper layer positioned above the base layer;
one or more support members positioned between the base layer and the upper layer and configured to support the upper layer above the base layer; and
one or more lock anchors configured to receive one or more locking mechanisms of the one or more accessories therein, the one or more lock anchors each comprising:
an open-topped central cavity configured to at least partially receiving one of the locking mechanisms therein; and
one or more side openings each configured to at least partially receive an extendable locking member of one of the locking mechanisms therein.

19. The mounting assembly of claim 18, wherein the base layer and the upper layer each comprise left and right wheel contours for positioning the mounting assembly in a cargo bed of the vehicle.

20. A mounting assembly for securing one or more accessories to a cargo bed of a vehicle, the mounting assembly comprising:
a base layer configured to be positioned on the cargo bed;
an upper layer positioned above the base layer;
a plurality of support members positioned between the base layer and the upper layer and evenly spaced from each other, the plurality of support members being at least partially formed of shock absorbing material and configured to support the upper layer above the base layer; and
a plurality of lock anchors orthogonally and evenly spaced from each other, the plurality of lock anchors being configured to receive one or more locking mechanisms of the one or more accessories therein, the one or more lock anchors each comprising:
a rectangular open-topped central cavity configured to at least partially receive one of the locking mechanisms therein; and
at least two side openings extending diagonally upwards from opposite sides of the open-topped central cavity, each side opening being configured to at least partially receive an extendable locking member of one of the locking mechanisms therein, the mounting assembly being configured to secure the one or more accessories in lateral and longitudinal orientations.
